(19) United States
(12) Patent Application Publication
(10) Pub. No.: US 2023/0296889 A1
(43) Pub. Date: Sep. 21, 2023

(54) HEAD-UP DISPLAY SYSTEM

(71) Applicant: Qisda Corporation, Taoyuan City (TW)

(72) Inventors: Chih-Kang PENG, Taoyuan City (TW); Tsung-Hsun WU, Taoyuan City (TW); Chih-Ming CHANG, Taoyuan City (TW)

(73) Assignee: Qisda Corporation, Taoyuan City (TW)

(21) Appl. No.: 18/096,067

(22) Filed: Jan. 12, 2023

(30) Foreign Application Priority Data
Mar. 21, 2022 (CN) 202210304548.X

(51) Int. Cl. G02B 27/01; G09G 3/00; G09G 3/34

(52) U.S. Cl. CPC G02B 27/0101; G09G 3/002; G09G 3/344; G09G 2380/10; G09G 2320/0626; G09G 2320/0666; G09G 2360/04

(57) ABSTRACT

A head-up display system for a vehicle is provided. The vehicle includes a dashboard body and a front window above the dashboard body. The head-up display system includes a display device. The display device includes a display screen. The display device is rotatably disposed on the dashboard body and shifts between a first position and a second position. When the display device is in the first position, the display screen of the display device faces the front window. When the display device is in the second position, the display screen does not face the front window.

This application claims the benefit of People's Republic of China patent application Serial No. 202210304548.X, filed Mar. 21, 2022, the invention of which are incorporated by reference herein in its entirety.

### TECHNICAL FIELD

The present invention relates in general to a head-up display system, and more particularly to a head-up display system for a vehicle.

### BACKGROUND

Head-up display (HUD) is a device that projects the driver's required information on the front window which the driver views, so the driver can see the required information directly on the viewing direction without looking down, which greatly enhances the safety of driving. Many car manufacturers currently make head-up display an option when purchasing a car, resulting in many car owners still unable to enjoy the convenience and safety that head-up display bring.

### SUMMARY

The present invention is directed to a head-up display system. The display device is rotatably disposed on the dashboard body and shifts between a first position and a second position, so that the display device may shift to different positions for different purposes.

According to one aspect of the present invention, a head-up display system for a vehicle is provided. The vehicle includes a dashboard body and a front window above the dashboard body. The head-up display system includes a display device. The display device includes a display screen. The display device is rotatably disposed on the dashboard body and shifts between a first position and a second position. When the display device is in the first position, the display screen of the display device faces the front window. When the display device is in the second position, the display screen does not face the front window.

According to another aspect of the present invention, a head-up display system for a vehicle is provided. The vehicle includes a dashboard body and a front window above the dashboard body. The head-up display system includes a display device. The display device includes a display screen and a sun protection surface facing in different directions. The display device is rotatably disposed on the dashboard body and shifts between a display position and a sun protection position. When the display device is in the display position, the display screen faces the front window. When the display device is in the sun protection position, the sun protection surface faces the front window.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows one embodiment of the head-up display system for a vehicle.

FIG. 2 is a schematic diagram of a local area inside the vehicle, showing the display device in the first position.

FIG. 3 is a cross-sectional view of FIG. 2.

FIG. 4 is a schematic diagram of a local area inside the vehicle, showing the display device in the second position.

FIG. 5 is a cross-sectional view of FIG. 4.

FIG. 6 is a block diagram of the head-up display system according to one embodiment of the present invention.

FIG. 7 shows a schematic diagram of the display screen of the display device displaying a first image.

FIG. 8 shows a schematic diagram of the display screen of the display device displaying a second image.

FIG. 9 shows the display device in another second position.

### DETAILED DESCRIPTION

Embodiments of the present invention will be described in detail hereinafter, and illustrated with the accompanying drawings. In addition to these detailed descriptions, the present invention may be broadly implemented in other embodiments, and any substitutable, modified, equivalent variations of the embodiments are included within the scope of the present invention. The scope of the present is subject to the claims thereafter. In the description of the specification, many specific details and examples of embodiments are provided in order to provide the reader with a more complete understanding of the present invention; however, these specific details and examples of embodiments should not be considered as limitations of the present invention. In addition, well-known steps or elements are not described in detail to avoid unnecessary limitations of the present invention.

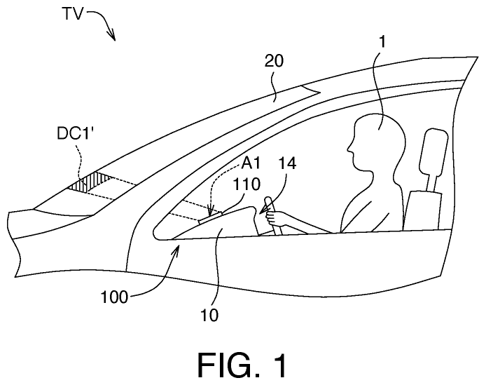

A head-up display system is provided in the present invention, which may be applied to a means of transportation, such as a vehicle. Referring to FIG. 1, one embodiment of the head-up display system 100 for a vehicle TV is shown. The vehicle TV includes, but is not limited to, an automobile, an airplane, a marine vessel, etc.

The vehicle TV includes a dashboard body 10 and a front window 20 above the dashboard body 10. The head-up display system 100 includes a display device 110, which is disposed on the dashboard body 10. Particularly, the display device is rotatably disposed on the dashboard body 10, and may shift between a first position and a second position.

The display device 110 may be any type of display, such as a liquid crystal display, a light emitting diode display, an organic light emitting diode display, an electroluminescent display, etc., and the present invention is not limited thereto. The display device 110 includes a display screen A1, and the display screen A1 may display an image such as driving information. As shown in FIG. 1, when the display device 110 is in the first position, the image displayed on display screen A1 may be projected on the front window 20 and form a reflective image DC1′ on the front window 20. The position of the reflective image DC1′ is within the viewing direction of the driver 1 when driving, so that the driver 1 does not need to look down to view the driving information, such as the dashboard information, to constitute the effect of head-up display.

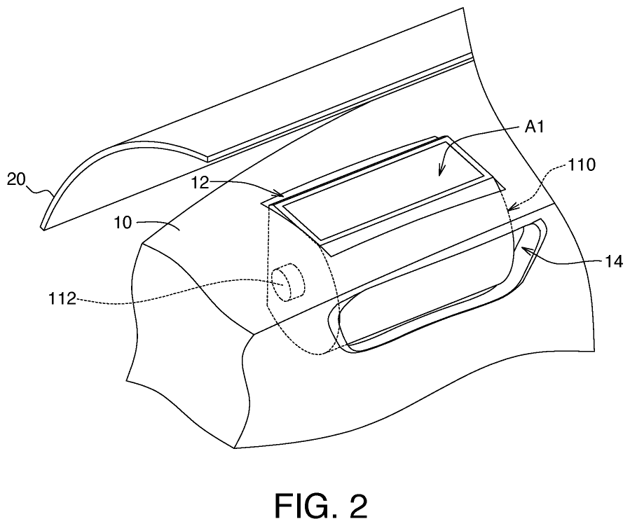

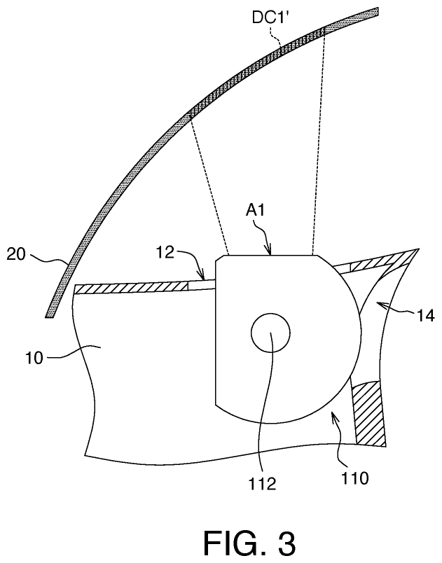

FIG. 2 is a schematic diagram of a local area inside the vehicle TV, showing the display device 110 in the first position; FIG. 3 is a cross-sectional view of FIG. 2. Referring to FIGS. 2 and 3, when the display device 110 is in the first position, the display screen A1 of the display device 110 may face the front window 20. In one specific embodiment, the dashboard body 10 may have an opening 12 facing the front window 20. When the display device 110 is in the first position, the display screen A1 of the display device 110 may be exposed from the opening 12 so that the image of the display surface A1 may be projected on the front window 20 to form the reflective image DC1′ on the front window 20.

In the present invention, the position of the display device 110 may be changed according to the demand. In one specific embodiment, the display device 110 may have a pivot 112. If the driver 1 wants to remove the effect of head-up display, the display device 110 may rotate about the pivot 112 and move to the second position. When the display device 110 is in the second position, the display screen A1 of the display device 110 does not face the front window 20.

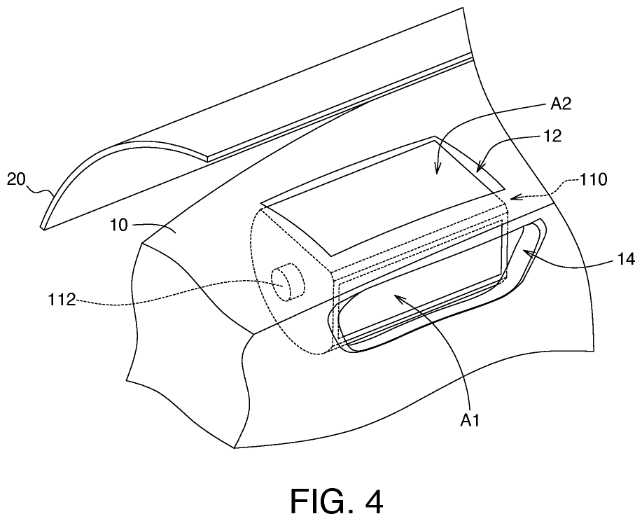

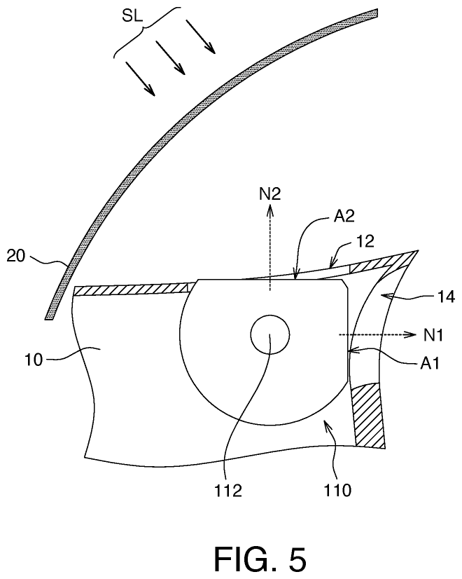

For example, when the display device 110 is in the second position, the display screen A1 of the display device 110 may face the driver 1. Referring to FIGS. 4 and 5, FIG. 4 is a schematic diagram of a local area inside the vehicle TV, showing the display device 110 in the second position; FIG. 5 is a cross-sectional view of FIG. 4. In one specific embodiment, the dashboard body 10 may further have a dashboard window 14, the position of which in relation to the driver 1 may be referred to FIG. 1. When the display device 110 is in the second position, the display screen A1 may be exposed from the dashboard window 14. The display screen A1 may display an image of the dashboard so that display device 110 may also be used as a dashboard.

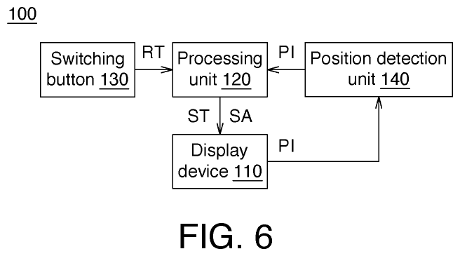

In one embodiment, the change of the position of the display device 110 may be performed in the following manner, which is not used to limit the present invention. FIG. 6 is a block diagram of the head-up display system 100 according to one embodiment of the present invention. Referring to FIG. 1 and FIG. 6, the head-up display system 100 may further include a processing unit 120, a switching button 130 and a position detection unit 140. The processing unit 120 is coupled to the switching button 130 and the position detection unit 140. The switching button 130 is, for example, a press button or a knob, which may be disposed on the center console of the vehicle TV. When the driver 1 wants to change the position of the display device 110, the driver 1 may operate the switching button 130 on the center console. At this time, the switching button 130 may transmit a position conversion request signal RT to the processing unit 120, and the processing unit 120 may transmit the position conversion signal ST to the display device 110 in accordance with the position conversion request signal RT to control the display device 110 to shift to the first position or the second position. The position detection unit 140 is coupled to the display device 110 for detecting the position information PI of the display device 110, and then transmitting the position information PI to the processing unit 120. When the processing unit 120 receives the position information PI, the processing unit 120 may send the screen adjustment signal SA to the display device 110 according to the position information PI to perform a screen frame adjustment on the display screen A1 of the display device 110.

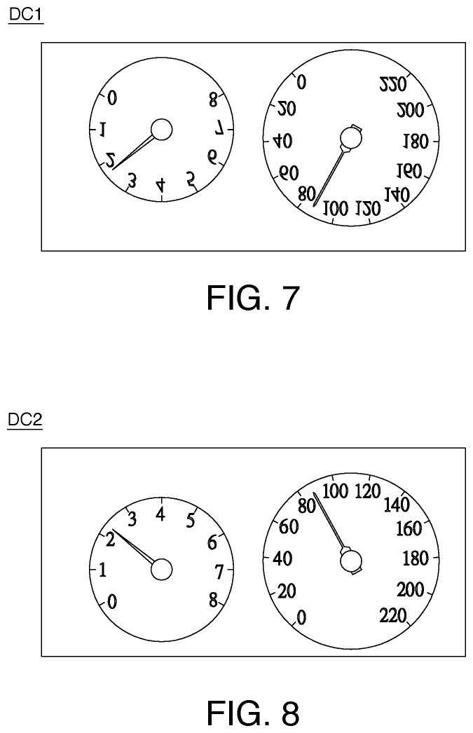

In one embodiment, the screen frame adjustment may include a mirror frame switch. FIG. 7 shows a schematic diagram of the display screen A1 of the display device 110 displaying a first image DC1; FIG. 8 shows a schematic diagram of the display screen A1 of the display device 110 displaying a second image DC2. The first image DC1 and the second image DC2 have a mirroring relationship. Referring to FIGS. 3, 6 and 7, when the display device 110 is in the first position (as shown in FIG. 3), the processing unit 120 may command the display screen A1 to display the first image DC1, which is the processed image by performing mirroring on the normal dashboard image. Thereby, when the first image DC1 is projected on the front window 20, the reflective image DC1′ is the normal dashboard image. Referring to FIGS. 5, 6 and 8, when the display device 110 shifts from the first position to the second position (as shown in FIG. 5), the processing unit 120 may perform the mirror frame switch on the display screen A1 to command the display screen A1 to display the second image DC2, which is the normal dashboard image, so that the display device 110 may be used as a dashboard.

In another embodiment, the screen frame adjustment may include an adjustment for color characteristic. For example, the adjustment for color characteristic may be a brightness adjustment to the display screen A1. When the display device 110 is in the first position (as shown in FIG. 3), the display screen A1 has a brightness greater than that of the display screen A1 of the display device 110 in the second position (as shown in FIG. 5). Since the display device 110 is in the first position, the reflective image DC1′ is the image projected on the front window 20, the display screen A1 should display the first image DC1 with a larger brightness to ensure that the reflective image DC1′ projected on the front window 20 still has sufficient brightness for the driver 1 to recognize. In other embodiments not illustrated, the adjustment for color characteristic may also be other processing related to color characteristic, such as color, color temperature, etc., but the present invention is not limited thereto.

In one embodiment, the display device 110 may include other display screen in addition to display screen A1. For example, referring to FIG. 4 and FIG. 5, the display device 110 may further include an electronic paper display screen A2 facing in a different direction than the display screen A1. Specifically, the display screen A1 may have a first normal line N1, and the electronic paper display screen A2 may have a second normal line N2. The first normal line N1 of display screen A1 and the second normal line N2 of the electronic paper display screen A2 may point to different directions; for example, the first normal line N1 may intersect the second normal line N2, or an angle of 180 degrees may be included between the first normal line N1 and the second normal line N2. When the display device 110 is in the second position as shown in FIG. 4 and FIG. 5, the electronic paper display screen A2 may be exposed from the opening 12. If the driver 1 needs to park temporarily, the electronic paper display screen A2 may, for example, display the driver 1's contact information, or a message that the driver 1 wants to leave, so that others can be informed in this way to avoid driving disputes.

Furthermore, in another embodiment, In case that the display device 110 includes the electronic paper display screen A2, the display device 110 may further include a solar panel (not shown) electrically connected to the electronic paper display screen A2. This solar panel may also be exposed from the opening 12 to convert solar energy into electricity and supply the electricity to the electronic paper display screen A2.

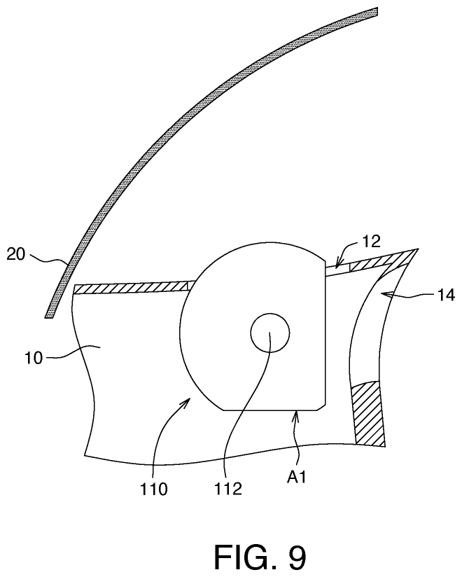

In some embodiments, the second position may be a plurality of positions other than the first position. That is, the second position may not be limited to the configuration of FIG. 4 and FIG. 5, but may be a plurality of positions in addition thereto. When the display device 110 is in the second position, the display screen A1 and the opening 12 may be staggered. For example, referring to FIG. 9, the display device 110 in another second position is shown. When the display device 110 is in the second position as shown in FIG. 9, the display screen A1 may be turned off to avoid unnecessary power waste.

In some embodiments, the aforementioned first position may be called the display position and the second position may be called the sun protection position. When the display device 110 is in the display position, the display device 110 may play the role of head-up display; when the display device 110 is in the sun protection position, because the display screen A1 and the opening 12 are staggered, therefore, as shown in FIG. 5, the sunlight SL does not directly irradiate the display screen A1 to avoid damage to the display screen A1 due to sunlight irradiation. In addition, when the display device 110 is in the sun protection position, the display device 110 may be changed to face the front window 20 with the sun protection surface. The sun protection surface may also be provided with relevant configurations that are not afraid of sunlight SL irradiation, such as the aforementioned electronic paper display screen A2 and/or solar panel, etc.

As described above, the present invention provides the display device rotatably disposed on the dashboard body, and the display device may shift between the first position and the second position, so that the display device may change its position for different purposes. For example, if the driver has the demand of head-up display during driving, the display device may shift to the first position to play the role of head-up display; if the driver does not have the demand of head-up display during driving, the display device may shift to the second position to be used as a dashboard; if the driver needs to park, the display device may shift away from the first position so that the sunlight does not directly irradiate the display screen; if the driver needs to park temporarily, the electronic paper display screen may face the front window so that the driver can leave the contact information or message.

It will be apparent to those skilled in the art that various modifications and variations can be made to the disclosed embodiments. It is intended that the specification and examples be considered as exemplary only, with a true scope of the present invention being indicated by the following claims and their equivalents.

What is claimed is:

1. A head-up display system for a vehicle, the vehicle comprising a dashboard body and a front window above the dashboard body, the head-up display system comprising:
a display device comprising a display screen, the display device rotatably disposed on the dashboard body and shifting between a first position and a second position;
wherein when the display device is in the first position, the display screen of the display device faces the front window;
when the display device is in the second position, the display screen does not face the front window.

2. The head-up display system according to claim 1, wherein when the display device is in the second position, the display screen faces a driver.

3. The head-up display system according to claim 2, further comprising a processing unit; wherein when the display device shifts between the first position and the second position, the processing unit performs a screen frame adjustment on the display screen.

4. The head-up display system according to claim 3, wherein the screen frame adjustment comprises an adjustment for color characteristic.

5. The head-up display system according to claim 4, wherein the adjustment for color characteristic is a brightness adjustment to the display screen; when the display device is in the first position, the display screen has a brightness greater than that of the display screen of the display device in the second position.

6. The head-up display system according to claim 3, wherein the screen frame adjustment comprises a mirror frame switch.

7. The head-up display system according to claim 1, wherein the dashboard body has an opening facing the front window; when the display device is in the first position, the display screen is exposed from the opening.

8. The head-up display system according to claim 7, wherein when the display device is in the second position, the display screen and the opening are staggered.

9. The head-up display system according to claim 8, wherein when the display screen and the opening are staggered, the display screen is turned off.

10. The head-up display system according to claim 7, wherein the display device further comprises an electronic paper display screen facing in a different direction than the display screen; when the display device is in the second position, the electronic paper display screen is exposed from the opening.

11. A head-up display system for a vehicle, the vehicle comprising a dashboard body and a front window above the dashboard body, the head-up display system comprising:
a display device comprising a display screen and a sun protection surface, the display screen and the sun protection surface facing in different directions, the display device rotatably disposed on the dashboard body and shifting between a display position and a sun protection position;
wherein when the display device is in the display position, the display screen faces the front window;
when the display device is in the sun protection position, the sun protection surface faces the front window.

12. The head-up display system according to claim 11, wherein when the display device is in the sun protection position, the display screen faces a driver.

13. The head-up display system according to claim 12, further comprising a processing unit; wherein when the display device shifts between the display position and the sun protection position, the processing unit performs a screen frame adjustment on the display screen.

14. The head-up display system according to claim 13, wherein the screen frame adjustment comprises an adjustment for color characteristic.

15. The head-up display system according to claim 14, wherein the adjustment for color characteristic is a brightness adjustment to the display screen; when the display device is in the display position, the display screen has a brightness greater than that of the display screen of the display device in the sun protection position.

16. The head-up display system according to claim 13, wherein the screen frame adjustment comprises a mirror frame switch.

17. The head-up display system according to claim 11, wherein the dashboard body has an opening facing the front window; when the display device is in the display position, the display screen is exposed from the opening.

18. The head-up display system according to claim 17, wherein when the display device is in the sun protection position, the display screen and the opening are staggered.

19. The head-up display system according to claim 18, wherein when the display screen and the opening are staggered, the display screen is turned off.

20. The head-up display system according to claim 17, wherein the sun protection surface comprises an electronic paper display screen; when the display device is in the sun protections position, the electronic paper display screen is exposed from the opening.
